(19) United States
(12) Patent Application Publication
(10) Pub. No.: US 2006/0021868 A1
(43) Pub. Date: Feb. 2, 2006

(54) Electrode for discharge surface treatment, a method of manufacturing the electrode for discharge surface treatment, and a discharge surface treatment method

(75) Inventors: Akihiro Goto, Tokyo (JP); Toshio Moro, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/206,789

(22) Filed: Aug. 19, 2005

Related U.S. Application Data
(63) Continuation of application No. 10/088,964, filed on Mar. 22, 2002.

(30) Foreign Application Priority Data
Sep. 30, 1999 (WO) PCT/JP99/05364

(51) Int. Cl. H05F 3/00

(52) U.S. Cl. 204/164; 427/580; 427/540

(57) ABSTRACT

cBN powder (11) which is an electrically insulating hard matter is mixed with Co-based alloy powder (12) which is a conductive matter, resultant powder mixture is put into a press mold and compression-molded to thereby form an electrode for discharge surface treatment (10). Electric discharge is generated between the electrode (10) and a treatment target material (16) by a discharge surface treatment power-supply unit (17), and a hard coat (20) made of cBN and Co-based alloy having high hardness even in a high temperature environment is formed on the treatment target material (16).

### TECHNICAL FIELD

The present invention relates to improvements in an electrode for discharge surface treatment, a method of manufacturing the electrode for discharge surface treatment, and a discharge surface treatment method. This electrode is used in a discharge surface treatment of generating an electric discharge between the electrode and a treatment target material, and forming a hard coat of the material of the electrode or of a matter obtained by reacting the electrode material by discharge energy on the surface of the treatment target material utilizing the energy radiated during the electrical discharge.

### BACKGROUND ART

Conventionally, as a technique which forms a hard coat on the surface of a treatment target material and applies corrosion resistance and abrasion resistance to the treatment target material, there is a discharge surface treatment method disclosed by, for example, Japanese Patent Application Laid-Open No. 5-148615. This technique is a discharge surface treatment method for a metallic material including two treatments. Namely, the primary treatment (deposition treatment) is performed using a green compact electrode which is an electrode for discharge surface treatment obtained by mixing WC (tungsten carbide) powder with Co (cobalt) powder and compression-molding the powder mixture, and the secondary treatment (re-melting treatment) is performed after replacing the green compact electrode by an electrode, such as a copper electrode, having relatively low electrode consumption. With this method, although it is possible to form a hard coat having high adhesion onto a steel product, it is difficult to form a hard coat having high adhesion onto a sintered material such as a cemented carbide.

Nevertheless, the studies carried by the inventor(s) show that if a material which forms a hard carbide such as Ti is used as the electrode and discharge is generated between the electrode and a metallic material which is a treatment target material, it is possible to form a rigid, hard coat on the surface of the metal which is the treatment target material without a re-melting process. This is because the electrode material consumed by the discharge reacts with carbon contained in a treatment solution and TiC (titanium carbide) is thereby formed. Our studies also show that if discharge is generated between a green compact electrode which is formed from a metallic hydride such as TiH₂ (titanium hydride) and a metallic material which is a treatment target material by the electrode, it is possible to swiftly form a hard coat having high adhesion compared with an electrode formed out of a material such as Ti. Our studies further show that if discharge is generated between a green compact electrode which is formed by mixing the other metal or ceramics with a hydride such as TiH₂, and a metallic material which is a treatment target material by the electrode, it is possible to swiftly form a hard coat exhibiting various properties such as high hardness and abrasion resistance.

The method as stated above is disclosed in, for example, Japanese Patent Application Laid-Open No. 9-192937. An example of the configuration of an apparatus used for such a discharge surface treatment will be described with reference to FIG. 10. In FIG. 10, reference numeral 1 denotes a green compact electrode which is an electrode for discharge surface treatment obtained by compression-molding TiH₂ powder, reference numeral 2 denotes a treatment target material, reference numeral 3 denotes a treatment bath, reference numeral 4 denotes a treatment solution, reference numeral 5 denotes a switching element switching a voltage and a current applied to the green compact electrode 1 and the treatment target material 2, reference numeral 6 denotes a control circuit on/off-controlling the switching element 5, reference numeral 7 denotes a power supply, reference numeral 8 denotes a resistor and reference numeral 9 denotes a hard coat formed. With such a configuration, it is possible to generate discharge between the green compact electrode 1 and the treatment target material 2 and to form the hard coat 9 on the surface of the treatment target material 2 made of steel, hard carbide or the like by discharge energy.

In the conventional discharge surface treatment method as stated above, the material of the electrode reacts with carbon generated by the decomposition of components in the treatment solution by discharge heat to thereby form a coat made of a hard carbide on the treatment target material.

As already described above, various types of electrodes are disclosed as the electrode for discharge surface treatment. However, the hard coat formed on the treatment target material by any one of these electrodes mainly contains a carbide. Hardness of the carbide suddenly decreases under a high temperature environment as shown in FIG. 11. Due to this fact, if a coat mainly containing the carbide is formed on a cutting tool or the like used under a high temperature environment, required properties such as corrosion resistance and abrasive resistance cannot be disadvantageously provided to the cutting tool or the like.

### DISCLOSURE OF THE INVENTION

It is an object of the present invention to provide an electrode for discharge surface treatment, a method of manufacturing the electrode for discharge surface treatment, and a discharge surface treatment method capable of forming a high hardness hard material on a treatment target material even under a high temperature environment.

The electrode for discharge surface treatment according to the present invention is used to generate discharge between the electrode and a treatment target material and forms a hard coat on a surface of the treatment target material. At least one hard matter having electrical insulating property and at least one matter having electrical conducting property are included as materials of the electrode.

Moreover, the hard matter is at least one of cBN (cubic boron nitride), diamond, B₄C (boron nitride), Al₂O₃ (aluminum oxide) , Si₃N₄ (silicon nitride) and SiC (silicon carbide).

The matter having electrical conducting property is at least one of metals forming a hard carbide such as Ti, W, Mo (molybdenum), Zr (zirconium), Ta (tantalum) and Cr (chromium) or at least one of iron-group metals such as Co, Ni (nickel) and Fe (iron).

The method of manufacturing an electrode for discharge surface treatment of generating an electric discharge between the electrode and a treatment target material and forming a hard coat on a surface of the treatment target material utilizing the energy radiated during the electrical discharge. The electrode is formed by mixing powder of a hard matter having electrical insulating property with powder of a matter having electrical conducting property and compression-molding resultant powder mixture.

Further, the method of manufacturing an electrode for discharge surface treatment according to the present invention provides an electrode to be used for a discharge surface treatment of generating an electric discharge between the electrode and a treatment target material and forming a hard coat on a surface of the treatment target material utilizing the energy radiated during the electrical discharge. The electrode is formed by conducting a heat treatment after mixing powder of a hard matter having electrical insulating property with powder of a matter having electrical conducting property and compression-molding resultant powder mixture.

Moreover, the electrode for discharge surface treatment is formed by adding wax to materials of the electrode, then compression-molding the material added with the wax, heating the compression-molded material at a temperature not less than a temperature of melting the wax and not more than a temperature of decomposing the wax to generate soot, and evaporating and removing the wax.

Further, the method of manufacturing an electrode for discharge surface treatment according to the present invention provides an electrode to be used for a discharge surface treatment of generating an electric discharge between the electrode and a treatment target material and forming a hard coat on a surface of the treatment target material utilizing the energy radiated during the electrical discharge. The electrode is formed by compression-molding powder obtained by coating powder of a hard matter having electrical insulating property with a matter having electrical conducting property or powder obtained by adding another powder material to the powder of the hard matter having electrical insulating property coated with the matter having electrical conducting property.

Further, the method of manufacturing an electrode for discharge surface treatment according to the present invention provides an electrode to be used for a discharge surface treatment of generating an electric discharge between the electrode and a treatment target material and forming a hard coat on a surface of the treatment target material utilizing the energy radiated during the electrical discharge. The electrode is formed by conducting a heat treatment after compression-molding powder obtained by coating powder of a hard matter having electrical insulating property with a matter having electrical conducting property or powder obtained by adding another powder material to the powder of the hard matter having electrical insulating property coated with the matter having electrical conducting property.

Further, the electrode for discharge surface treatment is formed by adding wax to material of the electrode, then compression-molding the material added with the wax, heating the compression-molded material at a temperature not less than a temperature of melting the wax and not more than a temperature of decomposing the wax to generate soot, and evaporating and removing the wax.

The discharge surface treatment method according to the present invention generates an electrical discharge between an electrode and a treatment target material and forms a hard coat on a surface of the treatment target material utilizing the energy radiated during the electrical discharge. The electrode includes at least one hard matter having electrical insulating property and at least one matter having electrical conducting property.

Further, the hard matter is at least one of cBN, diamond, B₄C, Al₂O₃, Si₃N₄ and SiC.

Further, the matter having electrical conducting property is at least one of metals forming a hard carbide such as Ti, W, Mo, Zr, Ta and Cr or at least one of iron-group metals such as Co, Ni and Fe.

Since the present invention is constituted as stated above, it is possible to form a hard coat having high hardness on the treatment target material even under a high temperature environment. The present invention has, therefore, advantages of being suited for the surface treatment of a cutting tool or the like used under a high temperature environment, and being capable of providing required properties, such as corrosion resistance and abrasion resistance, to the cutting tool or the like used under a high temperature environment.

### BRIEF DESCRIPTION OF THE DRAWINGS

FIG. 1 is across-sectional view which shows the concept of an electrode for discharge surface treatment and a manufacturing method thereof according to the first embodiment of the present invention;

FIG. 2 is a block diagram showing a discharge surface treatment method according to the first embodiment of the present invention;

FIG. 3 is an explanatory view which shows a manner in which a coat is formed on a treatment target material by the discharge surface treatment method according to the first embodiment of the present invention;

FIG. 4 shows the change of hardness relative to the temperature of cBN;

FIG. 5 is a cross-sectional view which shows the concept of an electrode for discharge surface treatment manufacturing method according to the second embodiment of the present invention;

FIG. 6 shows an example of the vapor pressure curve of wax mixed with an electrode for discharge surface treatment material during the compression molding of an electrode for discharge surface treatment according to the second embodiment of the present invention;

FIG. 7 is a cross-sectional view which shows the concept of an electrode for discharge surface treatment and a manufacturing method thereof according to the third embodiment of the present invention;

FIG. 8 is a cross-sectional view which shows an electrode for discharge surface treatment manufacturing method according to the fourth embodiment of the present invention;

FIG. 9 is a block diagram showing a discharge surface treatment method according to the fifth embodiment of the invention;

FIG. 10 is a block diagram showing an example of a conventional electrode for discharge surface treatment and a conventional discharge surface treatment apparatus; and

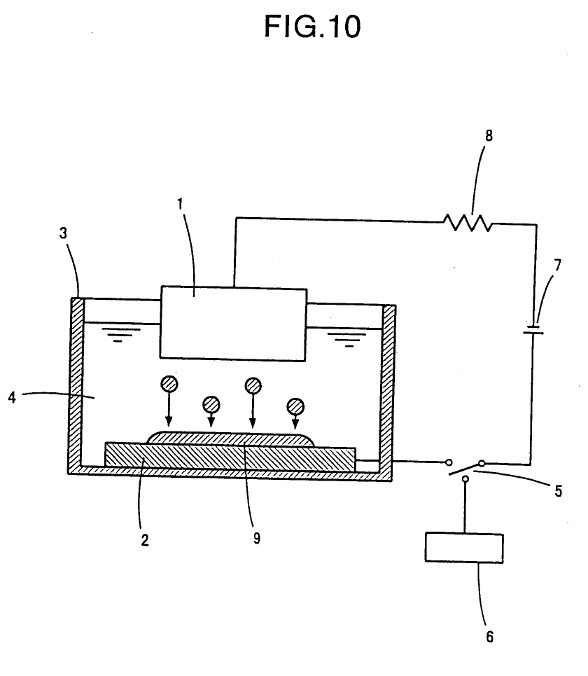

FIG. 11 shows the change of hardness relative to the temperature of a carbide.

### BEST MODE FOR CARRYING OUT THE INVENTION

### First Embodiment

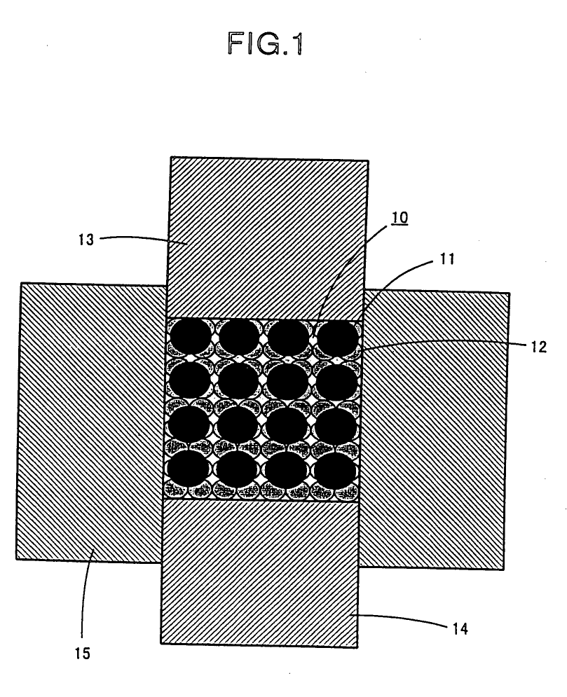

FIG. 1 is across-sectional view which shows the concept of an electrode for discharge surface treatment and a manufacturing method thereof according to the first embodiment of the present invention. In FIG. 1, reference numeral 10 denotes an electrode for discharge surface treatment, reference numeral 11 denotes cBN powder which is an electrically insulating hard matter, reference numeral 12 denotes Co-based alloy powder which is a conductive matter, reference numeral 13 denotes the upper punch of a mold, reference numeral 14 denotes the lower punch of the mold, and reference numeral 15 denotes a molding die. The cBN powder 11 and the Co-based alloy powder 12 are mixed together and the powder mixture is put into a press mold and compression-molded to thereby form the electrode 10.

Next, the method of manufacturing the electrode 10 will be described. If cBN containing coat is to be formed on a treatment target material by a discharge surface treatment, it is necessary to use cBN powder as an electrode material. The cBN powder is, however, electrically insulating material and cannot be, therefore, used as a sole electrode material. In addition, since cBN is hard, the powder cannot be hardened by compression molding using a press. As can be seen, since the cBN cannot be used as a sole material for the electrode 10, it is necessary to mix, as a binder, conductive metal or the like with the cBN powder so as to employ cBN as the material of the electrode 10.

That is, the CBN powder is mixed with binder powder and the powder mixture is put into a press mold in which the powder mixture is compression-molded to thereby produce the electrode 10.

Since cBN is an electric insulator, it is necessary to add the conductive binder in larger quantities if compression molding is performed by the press. The reason is as follows. While a cBN coat is formed by heat generated by discharge, it is to the conductive binder part on which discharge is actually generated on the electrode and no discharge is generated on the cBN which is an electric insulator. Particularly, if the electrode is formed only by the compression molding, then all the binder particles do not get electrically coupled to one another. Therefore, it is necessary to increase the quantity of the binder to, for example, preferably about 50% by weight.

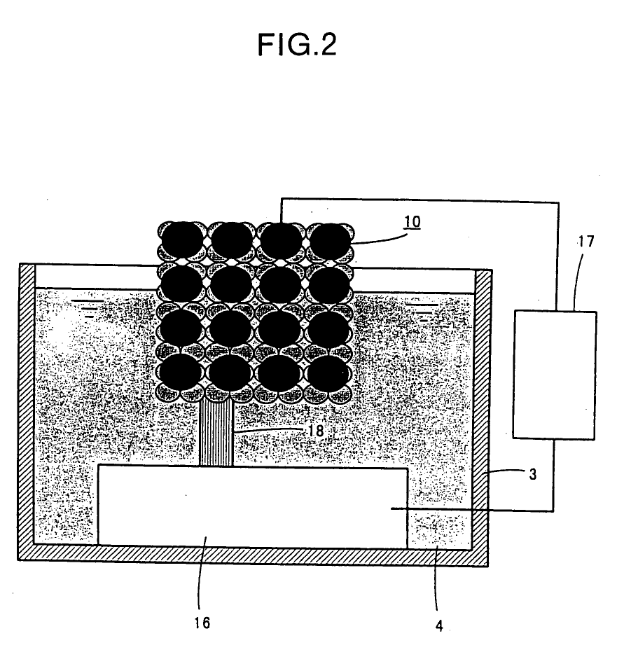

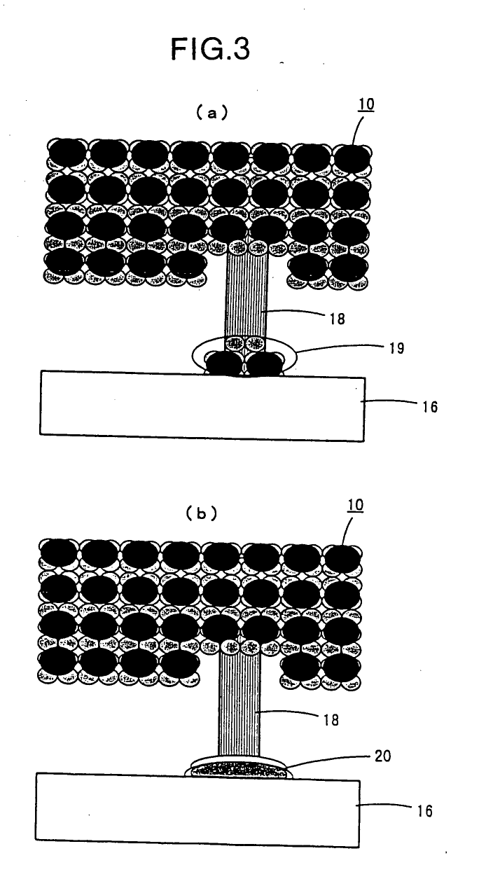

FIG. 2 is a block diagram showing a discharge surface treatment method according to the first embodiment of the invention. FIG. 3 shows a manner in which a hard coat is formed on a treatment target material by the discharge surface treatment method according to the first embodiment of the invention. In FIGS. 2 and 3, reference numeral 3 denotes a treatment bath, reference numeral 4 denotes a treatment solution, reference numeral 10 denotes the electrode for discharge surface treatment made of cBN and Co-based alloy, reference numeral 16 denotes a treatment target material, reference numeral 17 denotes a discharge surface treatment power-supply unit consisting of a DC power supply, a switching element, a control circuit and the like, reference numeral 18 denotes a discharge arc column, reference numeral 19 denotes an electrode for discharge surface treatment component molten by discharge heat and moved toward the treatment target material, and reference numeral 20 denotes a hard coat consisting of cBN and Co-based alloy. The discharge surface treatment power-supply unit 17 shown in FIG. 2 generates discharge between the electrode 10 and the treatment target material 16. The discharge is generated between a Co-based alloy part which is the conductive binder in the electrode 10 and the treatment target material 16. As shown in FIG. 3(a), the electrode 10 gets molten because of the electric discharge energy and the molten material 19 is dispersed in the portion between the electrode and the treatment target material. The molten material 19 is deposited onto the treatment target material 16 to thereby form a hard coat 20 made of cBN and Co-based alloy on the treatment target material 10 as shown in FIG. 3(b).

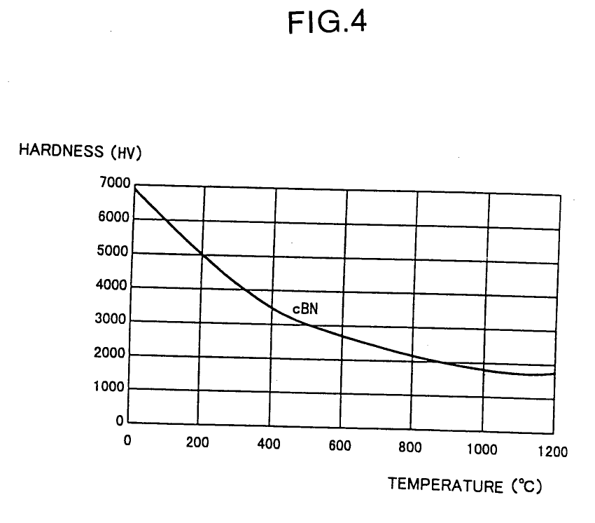

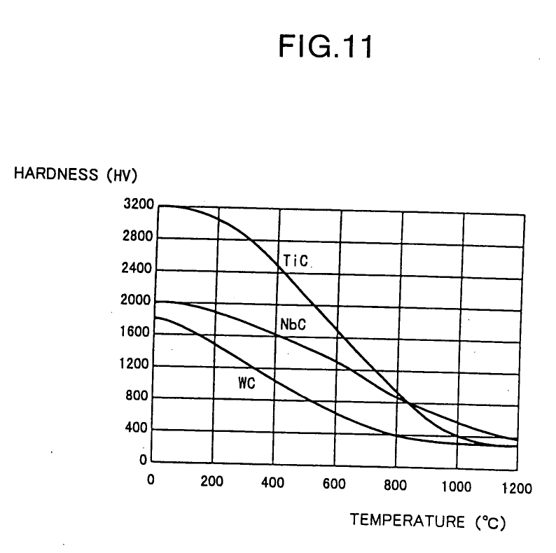

Since cBN has hardness close to that of diamond, the merit of forming a coat of cBN onto the treatment target material is quite large. Particularly, if the treatment target material is a tool and if it is coated with a diamond coat, then it cannot be used to treat iron material. Such tool is, therefore, mainly used to treat nonferrous metal. However, the tool coated with the cBN coat is suited for use when the treatment targets are iron-base materials which market size is dominant. In this way, the the tool coated with the cBN coat is quite convenient. Since the development of a method which deposits a thin cBN coat is slow, the discharge surface treatment method according to the present invention is of great significance. FIG. 4 shows the change of hardness relative to the temperature of cBN and indicates high hardness even under a high temperature environment compared with a case of the carbide shown in FIG. 11.

### Second Embodiment

The electrode for discharge surface treatment according to the first embodiment of the invention is formed by mixing cBN powder which is an electrically insulating hard matter with Co-based alloy powder which is a conductive matter and which is used as a binder, putting the powder mixture into a press mold and compression-molding the mixture. By conducting a heat treatment, if necessary, it is possible to make the electrode for discharge surface treatment exhibit desired strength in a certain range.

Since cBN is an electrically insulating matter, it is necessary to mix a conductive binder with cBN. If a heat treatment is conducted, however, binder components are molten and electric conductivity improves and the binder maybe, therefore, relatively in small quantities. As shown in the first embodiment of the invention, if the electrode is formed only by compression molding, it is desirable to set the quantity of the binder at about 50% by weight. If a heat treatment is conducted after compression molding, it is possible to obtain electrical conductivity usable as that of the electrode even with the quantity of the binder in a range of a few to several tens of percentage by weight.

If the electrode is formed only by compression molding, the material mixed with the powder which is an electrode material becomes an electrode component as it is. For that reason, it is not preferable to mix unnecessary components. If a heat treatment is conducted after compression molding, by contrast, it is possible to improve mold ability by adding a material which is evaporated if heat is applied thereto. For example, if wax is mixed with the powder serving as an electrode material, it is possible to considerably improve mold ability during the compression molding using a press.

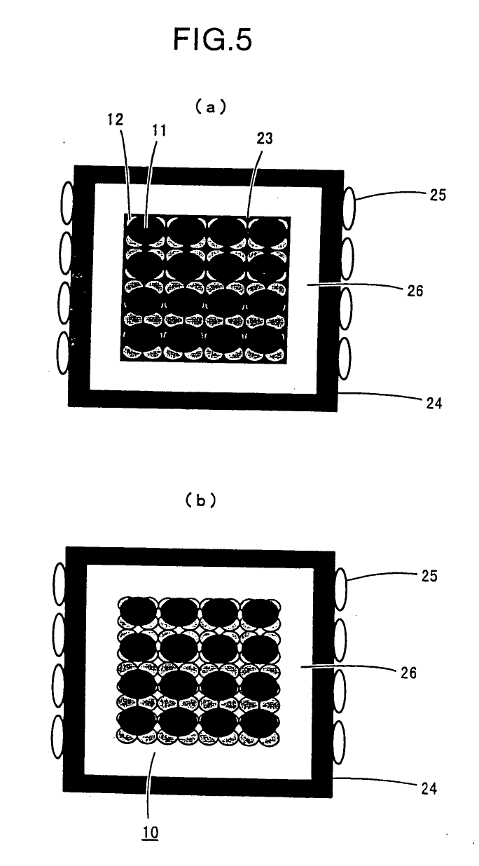

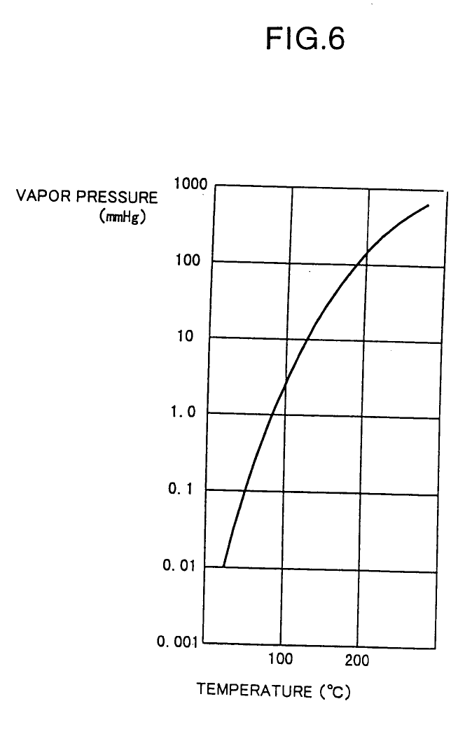

FIG. 5 shows a method of manufacturing an electrode for discharge surface treatment according to the second embodiment by mixing wax with an electrode material. In FIG. 5, reference numeral 10 denotes the electrode for discharge surface treatment, reference numeral 11 denotes cBN powder, reference numeral 12 denotes Co-based alloy powder, reference numeral 23 denotes wax such as paraffin, reference numeral 24 denotes a vacuum furnace, reference numeral 25 denotes a high frequency coil and reference numeral 26 denotes a vacuum atmosphere. By mixing the wax 23 with powder mixture of the cBN powder 11 and the Co-based alloy powder 12, compression-molding the resultant powder mixture and forming a green compact electrode, it is possible to greatly improve mold ability. However, because the wax 23 is an electrically insulating matter, if the wax 23 is left in the electrode in large quantities, the electric resistance of the electrode increases to thereby deteriorate discharge characteristic. It is, therefore, necessary to remove the wax 23. FIG. 5(a) shows a manner in which the green compact electrode mixed with the wax 23 is put in the vacuum furnace 24 and heated therein. While FIG. 5(a) shows that the heat treatment is conducted in the vacuum atmosphere 26, it may be conducted in an atmosphere of gas such as hydrogen or argon. The green compact electrode in the vacuum furnace 24 are subjected to a high frequency heat treatment by the high frequency coil 25 disposed around the vacuum furnace 24. At this moment, if heating temperature is too low, the wax 23 cannot be removed and if heating temperature is too high, the wax 23 is transformed into, soot to deteriorate the purity of the electrode. It is, therefore, necessary to keep the heating temperature to be not less than the temperature at which the wax 23 is molten and not more than the temperature at which the wax 23 is decomposed and transformed into soot. By way of example, FIG. 6 shows the vapor pressure curve of the wax having a boiling point of 250° C. If the atmospheric pressure of the vacuum furnace 24 is kept to be not more than the vapor pressure of the wax 23, the wax 23 is evaporated and removed and the electrode 10 can be obtained as shown in FIG. 5(b). If no wax is used, it is necessary to select a low hardness material as a binder material. If the wax is used, a hard material such as TiN (titanium nitride), TiC, HfC (hafnium carbide) or TICN (titanium carbide nitride) can be used as a binder, making it possible to further increase the hardness of a coat.

### Third Embodiment

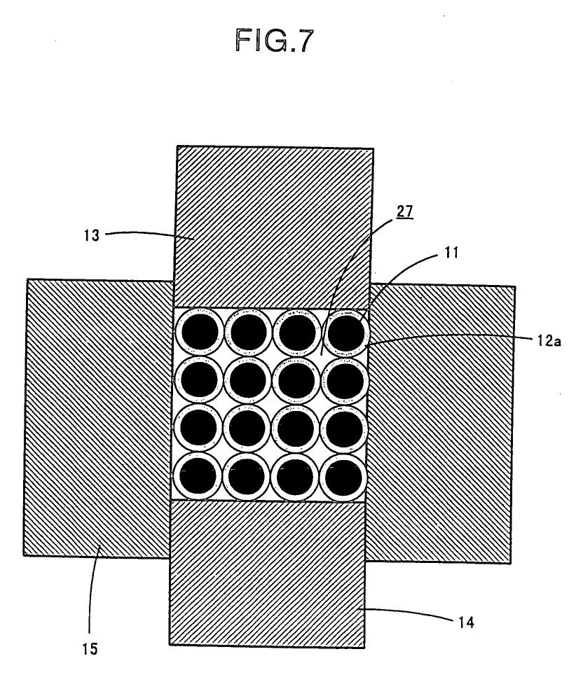

FIG. 7 is across-sectional view which shows the concept of an electrode for discharge surface treatment and a manufacturing method thereof according to the third embodiment of the present invention. In FIG. 7, reference numeral 11 denotes the cBN powder which is an electrically insulating hard matter, reference numeral 12a denotes a Co coat which is a conductive matter, reference numeral 13 denotes the upper punch of a mold, reference numeral 14 denotes the lower punch of the mold, reference numeral 15 denotes a molding die, and reference numeral 27 denotes an electrode for discharge surface treatment. The cBN powder 11 is coated with the Co coat 12a and such coating can be easily performed by evaporation or the like.

If the cBN powder 11 coated with the Co coat 12a as stated above is put into a press mold and compression-molded, the Co coat 12a is deformed and pressure-bonded by pressure applied by the press, whereby the Co coat 12a and the cBN powder 11 are integrated with each other as the electrode.

In the case of the electrode for discharge surface treatment 27 thus formed, the quantity of a binder material can be made smaller than those of the electrode for discharge surface treatments in the first and second embodiments of the invention. According to the discharge surface treatment employing the electrode 27, therefore, the percentage of cBN in the hard coat formed on the treatment target material increases, making it possible to form a hard coat having higher hardness.

In the discharge surface treatment using the electrode consisting of cBN and Co, since cBN is an electrically insulating matter, discharge is not directly generated on cBN but on Co which is the conductive binder. Heat energy generated by this discharge moves cBN as well as Co as the binder toward the treatment target material and a coat is formed on the treatment target hard material. In the discharge surface treatment using the electrode 27 according to the present invention, since the cBN powder 11 which is the electrically insulating hard matter and contained in the electrode 27 is coated with the Co coat 12a which is the conductive matter, the surfaces of the electrode 27 are completely conductive to make it possible to stably generate discharge.

Furthermore, since it is necessary to set the particle diameter of the cBN powder 11 coated with the Co coat 12a to be smaller than the distance between the electrode 27 and the treatment target material during the discharge surface treatment, it is preferable that the particle diameter of the cBN powder 11 is about not more than 10 μm. Accordingly, cBN needs to have a smaller particle diameter. Besides, it is preferable that the thickness of this Co coat is about not more than 1 to 2 μm. This is because if the Co coat is thicker, the ratio of the binder is higher. However, if the Co coat is extremely thin, the Co coat cannot function as a binder, so that the Co coat needs to be thick to a certain extent. For example, if the particle diameter of the cBN powder is 5 μm, the optimum thickness of the Co coat is about 1 μm.

### Fourth Embodiment

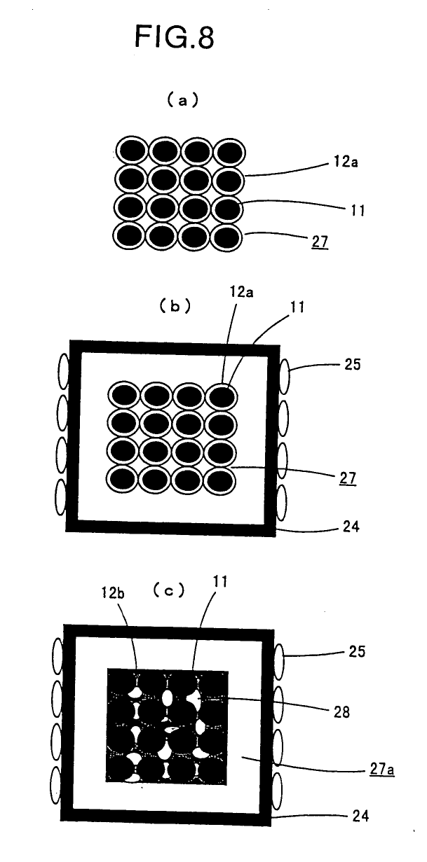

FIG. 8 is a cross-sectional view which shows a method of manufacturing an electrode for discharge surface treatment according to the fourth embodiment of the present invention. FIG. 8(a) shows the electrode 27 coated with a Co coat 12a and obtained by compression-molding cBN powder 11 by the method described in the third embodiment of the invention. In addition, FIG. 8(b) shows a state in which the electrode 27 shown in FIG. 8(a) are put in a vacuum furnace 24 and subjected to a high frequency heat treatment by a high frequency coil 25, and FIG. 8(c) shows the configuration of the electrode 27a after the heat treatment. Here, reference numeral 12b denotes Co after the heat treatment and reference numeral 28 denotes a bubble.

Even by compression-molding the cBN powder 11 coated with the Co coat 12, the molded electrode 27 has conductivity. However, since the Co coat 12a is only deformed and pressure-bonded to the electrode 27, the strength of the electrode 27 is low and a defect such as the breakage of the electrode 27 often occurs. In that case, by conducting a heat treatment to the compression-molded electrode, it is possible to intensify the strength of the electrode and improve the conductivity of the electrode. As explained with respect to the second embodiment of the invention, the same advantage can be obtained by conducting a heat treatment after the powder mixture of the cBN powder and the Co-based alloy powder is compression-molded. However, since the electrically insulating matter and the conductive matter are mixed together, it is required to set the heating temperature at not less than 1300° C. so as to intensify the electrode strength. Furthermore, since cBN has change in the crystal structure of hBN (hexagonal boron nitride) from about 1500° C., a property necessary as cBN cannot be obtained. Therefore, the problem that a property necessary as cBN cannot be obtained may possibly occur with the method which conducts a heat treatment after the powder mixture of the cBN powder and the Co-based alloy powder is compression-molded as described in the second embodiment of the invention. According to the method which conducts a heat treatment after the cBN powder 11 coated with the Co coat 12a is compression-molded as described in this fourth embodiment of the invention, by contrast, since each powder contacts with the metallic material or the coating material, it is possible to intensify the strength of the electrode by a heat treatment at relatively low temperature of, for example, not more than 1200° C. thanks to the heat conduction of this metallic material part. Consequently, the above-stated problem that a necessary property as cBN cannot be obtained does not occur.

Furthermore, the method which conducts a heat treatment after the cBN powder 11 coated with the Co coat 12a is compression-molded is described above. With a view of improving mold ability during the compression molding, if the same method as that shown in FIG. 5 in the second embodiment of the invention, i.e., method which mixes wax such as paraffin with the cBN powder 11 coated with the Co coat 12a in advance and removes the wax by evaporating the wax during the heat treatment is adopted, the molding of electrode is further facilitated. This method is particularly advantageous in the manufacturing of an electrode complex in shape or large in size.

### Fifth Embodiment

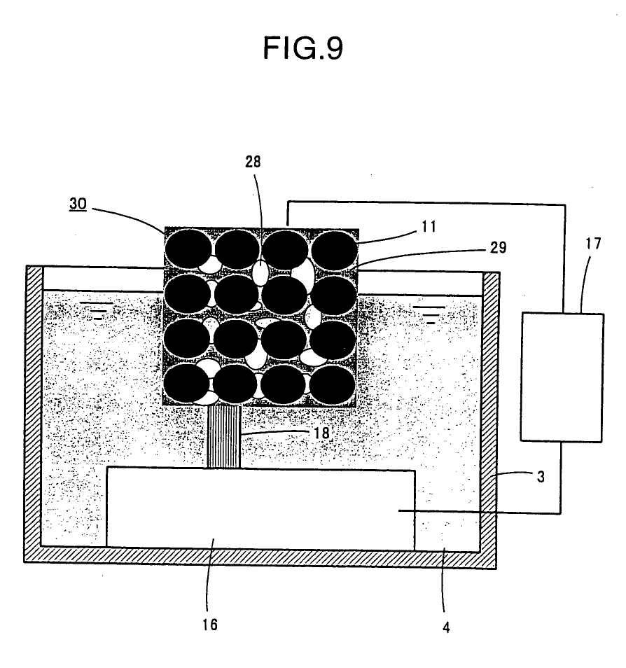

FIG. 9 is a block diagram showing a discharge surface treatment method according to the fifth embodiment of the present invention. In FIG. 9, reference numeral 3 denotes a treatment bath, reference numeral 4 denotes a treatment solution, reference numeral 11 denotes cBN powder, reference numeral 16 denotes a treatment target material, reference numeral 17 denotes a discharge surface treatment power-supply unit consisting of a DC power supply, a switching element, a control circuit and the like, reference numeral 18 denotes a discharge arc column, reference numeral 28 denotes a bubble, reference numeral 29 denotes Ti, and reference numeral 30 denotes an electrode for discharge surface treatment. The electrode 30 is formed by conducting a heat treatment after the cBN powder coated with a Ti coat is compression-molded.

A voltage is applied between the electrode 30 and the treatment target material 16 by the discharge surface treatment power-supply unit 17 to thereby generate pulse-like discharge. Since cBN is an electrically insulating matter, the discharge is generated on the Ti 29 part of the electrode 30. Heat energy generated by this discharge transforms a part of the electrode material into a molten state, the molten electrode material part is moved toward the treatment target material 16 by an explosive force due to this discharge and a coat containing cBN and Ti is formed on the treatment target material 16. If the treatment solution 4 is oil, Ti serving as a binder reacts with carbon which is a constituent element of the treatment solution 4 to form TiC and the coat formed on the treatment target material 16 becomes an extremely hard coat consisting of cBN and TiC.

While a case of cBN as the electrically insulating hard matter has been explained above, the electrically insulating hard matter is not limited to cBN. Diamond, B₄C, Al₂O₃, Si₃N₄, SiC or the like can be used as the electrically insulating hard matter.

Furthermore, it has been mentioned above that the conductive material mixed with or coating the electrically insulating hard material being Co and Ti. The conductive material is not limited to these materials. Metal forming a hard carbide such as W, Mo, Zr, Ta or Cr or iron-group metal such as Ni or Fe can be used as the conductive material.

### INDUSTRIAL APPLICABILITY

As stated so far, the electrode for discharge surface treatment, the method of manufacturing the electrode for discharge surface treatment, and the discharge surface treatment method according to the present invention are suited for use in industries associated with the surface treatment which forms a hard coat on the surface of a treatment target material.

1. An electrode for discharge surface treatment used for a discharge surface treatment of generating an electrical discharge between the electrode and a treatment target material and forming a hard coat on a surface of said treatment target material, wherein
at least one hard matter having electrical insulating property and at least one matter having electrical conducting property are included as materials of said electrode.

2. The electrode according to claim 1, wherein said hard matter is at least one of cBN, diamond, B₄C, Al₂O₃, Si₃N₄ and SiC.

3. The electrode according to claim 1, wherein said matter having electrical conducting property is at least one of metals forming a hard carbide such as Ti, W, Mo, Zr, Ta and Cr or at least one of iron-group metals such as Co, Ni and Fe.

4. A method of manufacturing an electrode for discharge surface treatment of generating an electric discharge between the electrode and a treatment target material and forming a hard coat on a surface of the treatment target material utilizing the energy radiated during the electrical discharge, wherein
said electrode is formed by mixing powder of a hard matter having electrical insulating property with powder of a matter having electrical conducting property and compression-molding resultant powder mixture.

5. A method of manufacturing an electrode for discharge surface treatment of generating an electric discharge between the electrode and a treatment target material and forming a hard coat on a surface of the treatment target material utilizing the energy radiated during the electrical discharge, wherein
said electrode is formed by conducting a heat treatment after mixing powder of a hard matter having electrical insulating property with powder of a matter having electrical conducting property and compression-molding resultant powder mixture.

6. The method according to claim 5, wherein said electrode is formed by adding wax to materials of said electrode, then compression-molding the material added with the wax, heating the compression-molded material at a temperature not less than a temperature of melting said wax and not more than a temperature of decomposing said wax to generate soot, and evaporating and removing said wax.

7. A method of manufacturing an electrode for discharge surface treatment according to the present invention provides an electrode to be used for a discharge surface treatment of generating an electric discharge between the electrode and a treatment target material and forming a hard coat on a surface of the treatment target material utilizing the energy radiated during the electrical discharge, wherein
said electrode is formed by compression-molding powder obtained by coating powder of a hard matter having electrical insulating property with a matter having electrical conducting property or powder obtained by adding another powder material to the powder of the hard matter having electrical insulating property coated with the matter having electrical conducting property.

8. A method of manufacturing an electrode for discharge surface treatment according to the present invention provides an electrode to be used for a discharge surface treatment of generating an electric discharge between the electrode and a treatment target material and forming a hard coat on a surface of the treatment target material utilizing the energy radiated during the electrical discharge, wherein
said electrode is formed by conducting a heat treatment after compression-molding powder obtained by coating powder of a hard matter having electrical insulating property with a matter having electrical conducting property or powder obtained by adding another powder material to the powder of the hard matter having electrical insulating property coated with the matter having electrical conducting property.

9. The method according to claim 8, wherein said electrode is formed by adding wax to material of said electrode, then compression-molding the material added with the wax, heating the compression-molded material at a temperature not less than a temperature of melting said wax and not more than a temperature of decomposing said wax to generate soot, and evaporating and removing said wax.

10. A discharge surface treatment method of generating an electric discharge between an electrode for discharge surface treatment and a treatment target material and forming a hard coat on a surface of said treatment target material utilizing the energy radiated during the electrical discharge, wherein
said electrode includes at least one hard matter having electrical insulating property and at least one matter having electrical conducting property.

11. The discharge surface treatment method according to claim 10, wherein said hard matter is at least one of cBN, diamond, B₄C, Al₂O₃, Si₃N₄ and SiC.

12. The discharge surface treatment method according to claim 10, wherein said matter having electrical conducting property is at least one of metals forming a hard carbide such as Ti, W, Mo, Zr, Ta and Cr or at least one of iron-group metals such as Co, Ni and Fe.
